(19) United States
(12) Patent Application Publication
(10) Pub. No.: US 2010/0210409 A1
(43) Pub. Date: Aug. 19, 2010

(54) HYBRID DRIVE TRAIN

(75) Inventors: Andreas Friesen, Siegburg (DE); Marco Brun, Duesseldorf (DE); Walter Burow, Bergisch-Gladbach (DE)

Correspondence Address: Davidson, Davidson & Kappel, LLC, 485 7th Avenue, 14th Floor, New York, NY, 10018, US

(73) Assignee: DEUTZ Aktiengesellschaft, Koein (DE)

(21) Appl. No.: 12/450,952

(22) PCT Filed: Apr. 15, 2008
(86) PCT No.: PCT/EP2008/002974

§ 371 Date: Feb. 25, 2010

(30) Foreign Application Priority Data
Apr. 15, 2007 (DE) 10 2007 019 156.3

(51) Int. Cl. B60W 10/04; B60K 6/36; B60W 20/00

(52) U.S. Cl. 477/3; 180/65.21; 180/65.265

(57) ABSTRACT

A hybrid powertrain of a motor vehicle, especially of a mobile machine having an internal combustion engine and an electric motor, the powertrain also having a hydraulic machine.

The invention relates to a hybrid powertrain of a motor vehicle, especially of a mobile machine having an internal combustion engine and an electric motor.

### BACKGROUND

Such a hybrid powertrain is known from the publication ATZ 7-8/2002, pages 664 to 674. There, the electric motor is connected to the internal combustion engine and also to a transmission. The transmission is connected to the driving wheels of a vehicle. In the version presented there, the electric motor is employed primarily as an integrated starter and generator, whereby it provides a slight amount of torque assistance for the internal combustion engine.

### SUMMARY OF THE INVENTION

It is an object of the present invention to improve such a hybrid powertrain of a motor vehicle.

The present invention provides a powertrain that also has a hydraulic machine.

According to the present invention, the following advantages are achieved:
fuel savings through an increase in the average utilization of the internal combustion engine;
improvement of the dynamic properties of the drive;
classification of the internal combustion engine in a more favorable emission category owing to the reduction of its power.

### Arrangement of the Components

The conventional powertrain of a mobile machine consisting of an internal combustion engine and hydraulic drive units is augmented by an electric motor that is arranged in parallel and that is put in the place of the flywheel. The electric motor is supplied by an electric energy reservoir via power electronics and it can be operated in all four quadrants.

### MODE OF OPERATION

The diesel-electric hybrid is operated with speed control in this arrangement. This means that the driver's wish is interpreted as the setpoint speed. This mode of operation has become well-established especially in the realm of mobile machines. In this context, even when the load varies (because of the operating hydraulics, the drive load or other driven units), the diesel-electric hybrid is supposed to regulate the speed desired by the device operator as accurately as possible in that the torque generated by the diesel-electric hybrid is adjusted accordingly.

### Start/Stop Function

In contrast to a conventional drive, the internal combustion engine (ICE) here is not started by a separate starter motor, but rather, directly by the electric motor. Unlike with a conventional powertrain, the internal combustion engine here can be started within a very short period of time (<200 ms), thus allowing the possibility of an automatic start/stop function.

The start/stop function means that the internal combustion engine is only operated when it is actually needed. In other words, if the internal combustion engine has been at a low idle for a certain period of time, it is switched off by the system.

As soon as the device operator actuates an operating component (for instance, gas pedal, steering wheel, actuating unit of the operating hydraulics, etc.), the internal combustion engine is immediately re-started so that the operator notices practically no delay.

By avoiding unnecessary idling times, this function translates into fuel savings.

### Booster Function

At appropriate operating points, the electric motor functions as a motor in order to increase the torque of the entire drive.

The requisite torque needed to maintain the speed desired by the device operator is calculated by means of a control algorithm and then implemented by the power electronics. In this process, the system takes into account all of the relevant states in the system such as, for example, the state of charge of the battery, the temperature of individual components, etc.

This function allows an internal combustion engine with a lower output to be used. Briefly needed peak outputs can be provided through the assistance of the electric motor in that it functions as a motor, so that the internal combustion engine no longer needs to be dimensioned for the needed or desired peak output.

Aside from the booster function that enables peak outputs, the possibility also exists for the electric motor to function as a motor to increase the dynamics of the powertrain.

Especially when the fuel volume injected into the internal combustion engine is restricted to a value below the ceiling curve by filling limitations that are dependent on the boost pressure, in order to improve the dynamics, the motor power of the electric motor can be continuously applied until this limitation is no longer needed, thanks to sufficient boost pressure.

### Charging Function

The electric energy reservoir can be charged in that the electric motor functions as a generator in order to generate a torque during operation. Here, the generated torque depends on the state of charge of the battery, on the utilization of the internal combustion engine and on various system conditions. The torque can be applied as the control variable of a regulator or else in a controlled manner.

### Recuperation Function

The term recuperation refers in general to the recovery of the mechanical braking energy, converting it into electric energy.

With conventional mobile machines, almost all of the braking energy is attained by the lugging effect of the internal combustion engine at high speeds and by systematically applying hydraulic loads.

With this configuration of a hybrid powertrain, the braking energy is achieved by applying a braking torque to the electric motor. As a result, on the one hand, high motor speeds are avoided and, on the other hand, the braking energy is fed to the electric energy reservoir via the electric motor and via the power electronics.

### Load-Point Shift Function

The function of a load-point shift is employed, among other things, to reduce CO₂ emissions and fuel consumption in hybrid powertrains of mobile machines consisting of the following components according to the invention: an internal combustion engine (diesel engine), an electric motor with a converter, an electric energy reservoir and a hydraulic mechanical and working drive.

By means of this function, the appertaining operating points in the characteristic curve family of the internal combustion engine (torque as a function of the rotational speed) are shifted along the curves of constant output (output hyperboles) in order to shift the operating points of the internal combustion engine into the ranges of optimal fuel consumption at a given moment.

In order to implement this functionality, electronically controlled hydraulic drive units (hydraulic pumps and hydraulic motors) are needed by means of which the transmission ratio can be continuously adjusted. The consequently greater number of degrees of freedom in the powertrain can be employed to freely select the setpoint speed of the internal combustion engine within certain ranges. Moreover, the holding volume of the hydraulic drive units can be adapted in such a way that the maximum driving speed of the mobile machine can be provided at operating points of the internal combustion engine that entail optimal fuel consumption.

During the load-point shift, the hybrid system control device ascertains the optimal setpoint speed as a function of a number of parameters—the current torque of the internal combustion engine, the current torque of the electric motor, the state of charge of the energy reservoir and the current rotational speed of the internal combustion engine and of the electric motor—by means of an operating strategy that is implemented in the hybrid system control device and this speed is relayed as the setpoint value to the speed regulator located downstream.

Here, the speed regulator is located in the hybrid system control device. The control deviation between the setpoint speed and the actual speed serves as the input variable for this speed regulator. Owing to the parallel arrangement of the internal combustion engine and the electric motor, one speed regulator is used for both components. The speed regulator is limited by the maximum and minimum cumulative torques of the internal combustion engine and electric motor. The output variable of the speed regulator is the control variable “torque” which, in the operating strategy that follows the speed regulator, is divided among the components “internal combustion engine” (diesel engine) and “electric motor”, taking into consideration the target criteria “optimal fuel consumption” and “optimal dynamics”, and this control variable is relayed to these components as the appertaining setpoint torque.

In comparison to conventional powertrains of mobile machines, the use of the load-point shift function entails the following advantages with a hybrid drive:
In the case of a conventional drive, due to the very dynamic load changes of the mechanical and working drive during the operation of the internal combustion engine, a high output reserve is available so that it is possible to react appropriately to the load changes. Particularly in case of boosted internal combustion engines, this output reserve is necessary in order to reduce the time needed to build up the boost pressure. With hybrid powertrains, the possibility exists to markedly reduce this output reserve of the internal combustion engine. When the dynamic load changes, the motor output of the electric motor is applied until the internal combustion engine reaches an operating point in which it is capable of generating the required output on its own. This strategy is promoted especially by the possibility of quickly regulating the torque of the electric motor.
In conventional drives, the load-point shift towards lower rotational speeds and thus higher torques is possible at the maximum up to the rotational speed of the internal combustion engine at which the engine generates the maximum rotational speed. The reason for this is that, at rotational speeds lower than the rotational speed at the maximum torque, a load change quickly leads to or can lead to stalling of the internal combustion engine. With hybrid powertrains, the motor output of the electric motor is likewise used to move the internal combustion engine to an operating point at which it is capable of generating the required output on its own.

### BRIEF DESCRIPTION OF THE DRAWINGS

Other advantageous configurations of the invention can be gleaned from the drawing description in which an embodiment of the invention depicted in the figure is described in greater detail.

The following is shown:

FIG. 1—a schematic view of the arrangement and the interaction among the individual components;

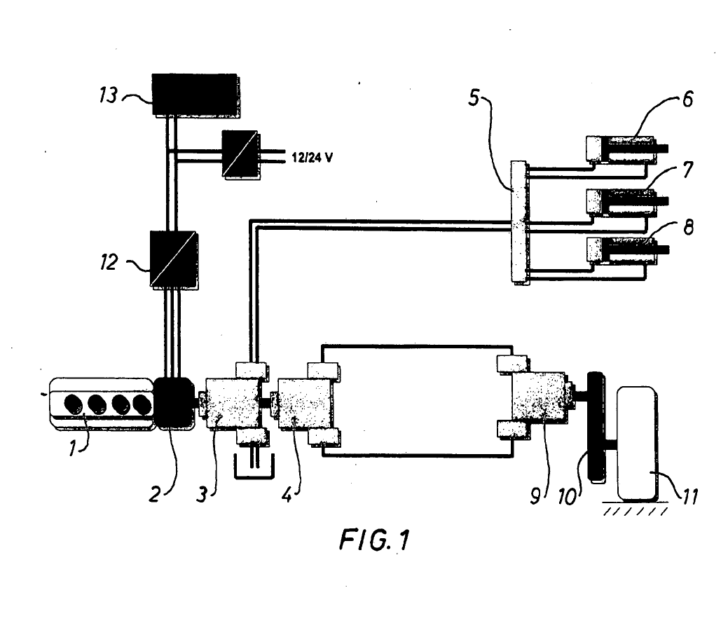

FIG. 2—the function of the load-point shift in a characteristic curve family;

FIG. 3—the “load-point shift” function in a characteristic curve family.

### DETAILED DESCRIPTION

An internal combustion engine 1, which especially is a self-igniting internal combustion engine (diesel engine), is coupled directly to an electric motor 2 that is connected to the crankshaft of the internal combustion engine 1 in place of a flywheel. The stator of this electric motor 2 is joined to the crankcase and the rotor is connected to the crankshaft. Furthermore, the rotor is connected to a gear pump 3 and also to an axial piston pump 4. The outlet of the gear pump 3 is connected via proportional valves 5 (for example) to an operating cylinder 6, to a lifting cylinder 7 and to a guide cylinder 8. The gear pump 3 and the axial piston pump 4 are hydraulic machines.

The axial piston pump 4 is connected to an axial piston motor 9 that is connected via a gear stage 10 to one or more driving wheels 11 of the mobile machine. The gear stage 10 normally has a fixed reduction ratio although it can also be configured as a manual transmission. It is likewise conceivable to use a gear that can be set steplessly. Together with the gear ratio—which can be varied over a broad range—between the input shaft of the second axial piston pump 4 and the output shaft of the axial piston motor 9, numerous possibilities exist to set, on the one hand, the rotational speed of the driving wheels 11 (and thus the speed of the vehicle) and, on the other hand, the rotational speed of the crankshaft of the internal combustion engine 1 at a given speed of the vehicle.

The electric motor 2 is connected to an electric energy reservoir 13 via a four-quadrant converter 12. Moreover, a hybrid system control device is provided with which all individual control devices of the components, especially of the powertrain and of the reservoir group, can be coordinated.

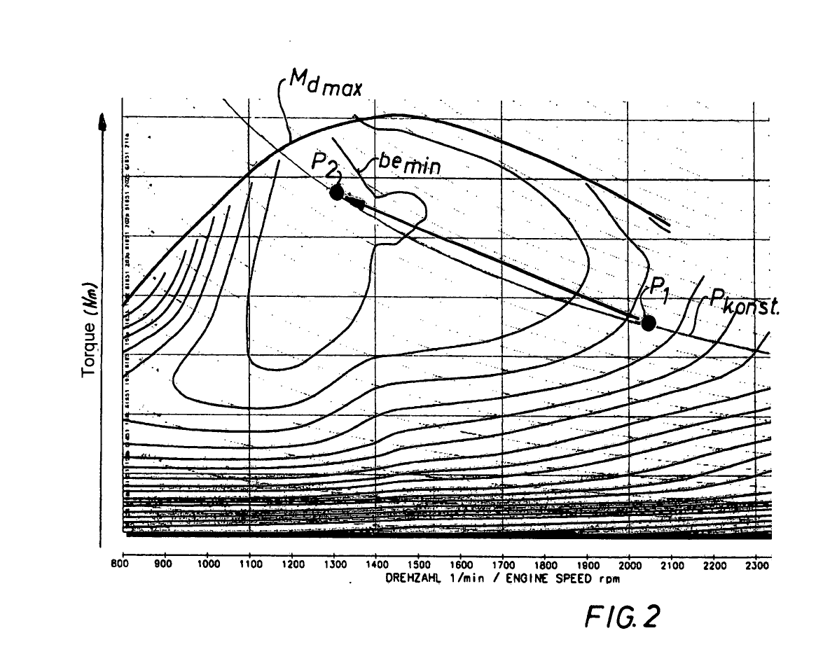

FIG. 2 shows a typical characteristic curve family of an internal combustion engine (torque as a function of the rotational speed). The maximum torque M_{dmax} that can be attained by the internal combustion engine is plotted as the ceiling curve in this characteristic curve family. The lines indicating a constant specific (fuel) consumption appear under this ceiling curve in the form of shell-shaped curves, whereby, starting at the beₘᵢₙ line, the other lines indicate an incremental rise in consumption. Finally, the curves indicating a constant output Pₖₒₙₛₜ (output hyperboles) of the internal combustion engine are also plotted. Fundamentally, the internal combustion engine, which is operated at a constant output Pₖₒₙₛₜ at point P₁, can now be operated at the same constant output Pₖₒₙₛₜ at point P₂, whereby the point P₂ lies in the beₘᵢₙ field. This adjustment achieves a drop in consumption of the internal combustion engine while the output remains the same.

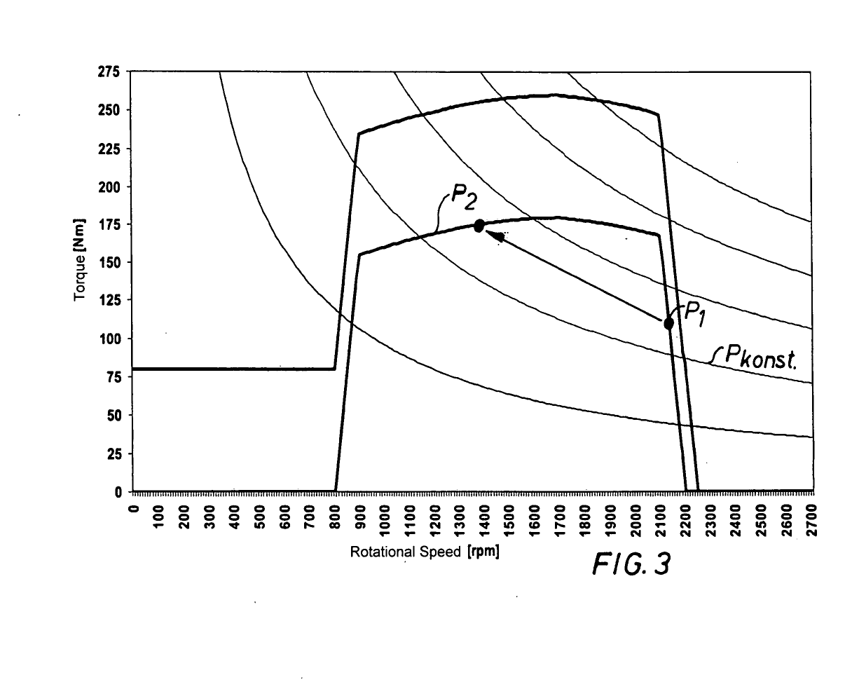

However, one problematic aspect of such a conventional powertrain is that such an adjustment—as shown in FIG. 3—is always associated with an approximation to the ceiling curve of the maximum achievable torque. If, as depicted in FIG. 3, the ceiling curve with the output point P₂ is reached during the adjustment, then the internal combustion engine no longer has any output reserves, even in the case of small load changes, and the internal combustion engine stalls. With the configuration according to the invention, however, the output that can be produced by the electric motor is still additionally available. In other words, the output can be adjusted up to the M_{dmax} curve without any problem for purposes of reducing consumption, without the need to fear that the internal combustion engine will stall in case of load changes since, in such a scenario, the additional output of the electric motor is available.

### REFERENCE NUMERALS

1 internal combustion engine
2 electric motor
3 gear pump
4 axial piston pump
5 proportional valves
6 operating cylinder
7 lifting cylinder
8 guide cylinder
9 axial piston motor
10 gear stage
11 driving wheels
12 four-quadrant converter
13 energy reservoir

What is claimed is:

1-7. (canceled)

8. A hybrid powertrain of a motor vehicle, especially of a mobile machine having an internal combustion engine and an electric motor, the hybrid powertrain comprising:
a hydraulic machine.

9. The hybrid powertrain as recited in claim 8 wherein the hydraulic machine is an axial piston pump.

10. The hybrid powertrain as recited in claim 8 wherein a hydraulic motor is connected to the hydraulic machine.

11. The hybrid powertrain as recited in claim 10 wherein the hydraulic motor is an axial piston motor.

12. The hybrid powertrain as recited in claim 8 further comprising a hydraulic control element controlled by the machine and connected via one or more proportional valves.

13. The hybrid powertrain as recited in claim 12 wherein the hydraulic control element includes one of an operating cylinder, a lifting cylinder and a guide cylinder.

14. The hybrid powertrain as recited in claim 8 wherein the powertrain includes a speed control.

15. The hybrid powertrain as recited in claim 8 wherein the hybrid powertrain is controllable so that a load-point shift can be set on the internal combustion engine.

16. The hybrid powertrain as recited in claim 15 wherein the load-point shift takes place all the way into the range when a maximum torque of the internal combustion engine is reached, and in that then the electric motor is actuated.

17. A method for operating the hybrid powertrain as recited in claim 8 comprising controlling the powertrain to set a load-point shift on the internal combustion engine.

18. The method as recited in claim 17 further comprising actuating the electric motor after the load-point shift occurs, the load point-shift occurring when a maximum torque of the internal combustion engine is reached.
